(19) United States
(12) Patent Application Publication
(10) Pub. No.: US 2026/0118564 A1
(43) Pub. Date: Apr. 30, 2026

(54) PARTIALLY TRANSPARENT AND PARTIALLY RETROREFLECTIVE OPTICAL COMPONENT WITH PLANE-SYMMETRICAL DEVIATION

(71) Applicant: COMMISSARIAT A L'ENERGIE ATOMIQUE ET AUX ENERGIES ALTERNATIVES, Paris (FR)

(72) Inventor: Christophe MARTINEZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/368,083

(22) Filed: Oct. 24, 2025

(30) Foreign Application Priority Data
Oct. 28, 2024 (FR) FR2411775

(51) Int. Cl. G02B 5/124; G03B 21/625

(52) U.S. Cl. CPC G02B 5/124; G03B 21/625

(57) ABSTRACT

The invention relates to an optical component comprising a first transparent layer (11) comprising retroreflective micro-recesses (13) in the form of a truncated pyramid; and a second transparent layer (20) extending on and in contact with the first layer (11) and the micro-recesses (13). The micro-recesses (13) are arranged in separate retroreflective strips parallel to one another, the retroreflective strips being separated two by two by a transparent longitudinal portion not comprising micro-recesses; the micro-recesses (13) of one and the same retroreflective strip being up against one another and oriented along a transverse axis of the retroreflective strip.

### TECHNICAL FIELD

The field of the invention is that of partially transparent and partially retroreflective optical components comprising micro-recesses in the form of a truncated pyramid. It finds an application in imaging, especially in floating imaging.

### PRIOR ART

Partially transparent and partially retroreflective optical components are known. Such an optical component is substantially planar, and comprises a first transparent layer of which one face is structured to form cube-corner micro-recesses. A second transparent layer may be attached to the microstructured face of the first layer by means of a transparent adhesive. The retroreflective micro-recesses are adapted to retroreflect the light that is incident on the second transparent layer. They are each surrounded by a transparent portion so that incident light is transmitted (with refraction) through the optical component without retroreflection.

This optical component may be used as a display screen, as for example in the floating imaging system described in the document WO 2018/069625 A1, or as an improved windshield as described in the document EP 3,141,952 A1. Such an optical component is then adapted to retroreflect the light of an image to be displayed, and to transmit the opposite light coming from the scene.

It should be noted that the cube-corner retroreflective micro-recesses may have the shape of a truncated pyramid, in which the retroreflective trihedron is formed by the top face of the pyramid and by two lateral faces thereof. These three faces are perpendicular to each other, and the top face is also parallel to the base of the pyramid and to the mean plane of the optical component. This configuration is described in detail in document WO 2021/104739 A1.

However, there is a need to improve at least in part certain aspects of such an optical component.

### DISCLOSURE OF THE INVENTION

The aim of the invention is to provide a partially transparent and partially retroreflective optical component configured to converge light rays according to planar symmetry with respect to a main plane in which the optical component extends, and this with optimized transmission efficiency.

For this purpose, the object of the invention is an optical component extending in a main plane, and having an input face and an opposite output face, both planar and parallel to the main plane, comprising: a first transparent layer, having the entry face, and a second opposite face, planar and parallel to the main plane, and comprising retroreflective micro-recesses in the form of a truncated pyramid, extending from the second face; and a second transparent layer, having the exit face, and extending on and in contact with the second face of the first layer and the micro-recesses.

According to the invention, the micro-recesses are arranged in separate retroreflective strips parallel to one another, the retroreflective strips being separated two by two by a transparent longitudinal portion not comprising micro-recesses; the micro-recesses of one and the same retroreflective strip being up against one another and oriented along a transverse axis of the retroreflective strip.

Some preferred but non-limitative aspects of this optical component are as follows.

The micro-recesses of one of the same strip can all have the same dimensions.

The micro-recesses may each have a square top face of the truncated pyramid and a square base, parallel to the top face and coplanar with the second face of the first layer.

The micro-recesses may each have a trihedron formed by the top face and two lateral faces orthogonal to each other and to the top face.

The micro-recesses can each have a first diagonal formed from a point common to the trihedron and at the opposite point of the base, this diagonal being substantially oriented along the transverse axis of the retroreflective strip.

In one and the same retroreflective strip, the micro-recesses may be arranged periodically according to a pitch substantially equal to the dimension of a diagonal from the orthogonal base to the first diagonal.

The optical component may comprise a reflective layer that covers the inner surface of the micro-recesses as well as an intermediate surface of the second face of the first layer located between two neighboring micro-recesses.

Retroreflective strips can be straight or concentric.

Each retroreflective strip may comprise, along its transverse axis, between 2 and 15 micro-recesses.

The entry face may be intended to be illuminated by a light beam with a non-zero mean angle of incidence α₀, which is refracted to form in a light beam having a non-zero angle α₁ with respect to an axis orthogonal to the main plane. In addition, the retroreflective strips may be arranged next to each other alongside the sides at the pitch Lm, the second layer then having a thickness D; the values D and Lm being selected to satisfy the equation:

$$D = \frac{Lm}{4 \times tan {α}_{1}} mod \frac{Lm}{2 \times tan {α}_{1}} .$$

Two neighboring micro-recesses of one and the same retroreflective strip may be spaced apart from each other by a distance at most equal to a fifth of their depth and preferably at most equal to a tenth of their depth.

The invention also relates to a floating imaging system, comprising: an image-forming component, adapted to provide an image; and the optical component according to any one of the preceding features, its entry face being oriented towards the image-forming component and arranged inclined to an optical axis of the latter.

The floating imaging system may comprise an absorbent structure located opposite the entry face of the optical component so as to receive the light beams coming from the image-forming component and reflected by the entry face.

The image-forming component may comprise: a projector of an image, comprising an image source and an optical system; and a transparent diffuser, located in the image plane of the optical system, adapted to transmit and backscatter the image received from the projector.

### BRIEF DESCRIPTION OF THE DRAWINGS

Other aspects, aims, advantages and characteristics of the invention will become apparent upon reading the following detailed description of preferred embodiments thereof, provided as a non-limiting example, and made with reference to the accompanying drawings wherein:

FIG. 1A is a diagrammatic, partial, cross-sectional view of an optical component according to one example of the prior art;

FIG. 1B is a perspective view of a micro-recess in the form of a truncated pyramid of the optical component of FIG. 1A;

FIG. 2 is a schematic, partial, cross-sectional view of the optical component of FIG. 1A, illustrating the cast shadow;

FIG. 3A is a schematic, partial, cross-sectional view of an optical component according to one embodiment;

FIG. 3B is a cross-sectional view of micro-recesses of the optical component of FIG. 3A;

FIG. 3C is a plan view of micro-recesses of the optical component of FIG. 3A;

FIG. 4A is a schematic, partial, plan view of retroreflective strips of an optical component according to an embodiment;

FIG. 4B is a schematic, partial, perspective view of an optical component comprising retroreflective strips similar to those of FIG. 4A;

FIG. 5A is a schematic, partial, plan view of retroreflective strips of an optical component according to another embodiment;

FIG. 5B is a schematic, partial, perspective view of an optical component comprising retroreflective strips similar to those of FIG. 5A;

FIG. 6 is a schematic, partial, cross-sectional view of a floating imaging system comprising an optical component according to one embodiment;

FIGS. 7A and 7B illustrate an angular dependence of a retroreflection efficiency n in the case (FIG. 7A) of an optical component similar to that of FIGS. 1A and 1n the case (FIG. 7B) of an optical component similar to that of FIG. 3A.

### DETAILED DISCLOSURE OF SPECIFIC EMBODIMENTS

In the figures and in the following description, the same references represent identical or similar elements. Furthermore, the different elements are not represented to scale so as to improve the clarity of the figures. Moreover, the different embodiments and alternatives are not mutually exclusive and could be combined together. Unless stated otherwise, the terms “substantially”, “about”, and “in the order of” mean to within 10%, and preferably to within 5%. Moreover, the terms “between . . . and . . . ” and equivalents mean that the bounds are inclusive, unless specified otherwise.

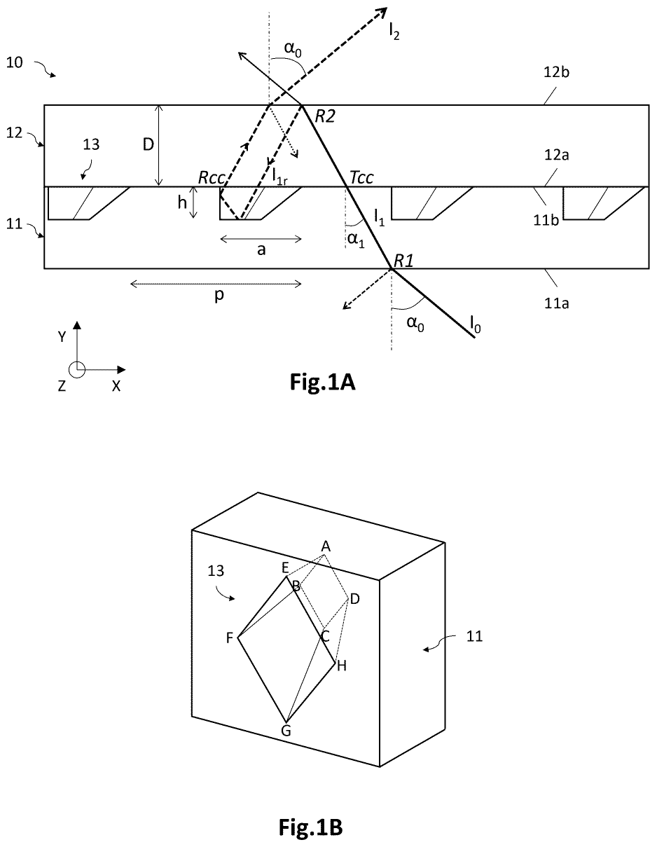

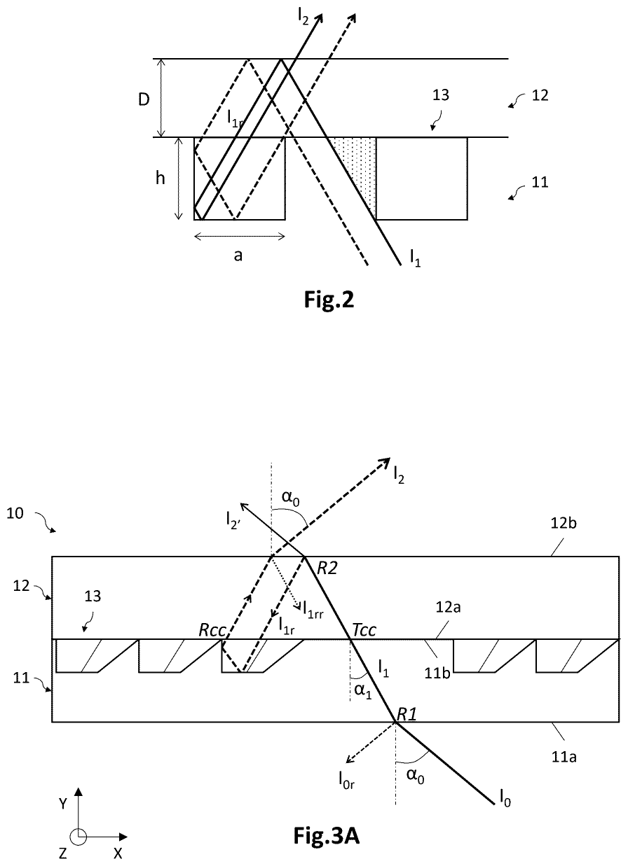

FIGS. 1A and 1B illustrate an example of an optical component 10 that differs from the examples of the prior art mentioned previously in that the micro-recesses 13 in the form of a truncated pyramid are oriented towards the exit face 12b and not, as in the prior art, towards the entry face 11a. This is to introduce the problem of the cast shadow highlighted later in connection with FIG. 2.

Here and hereinafter in the description, an orthogonal three-dimensional direct reference frame XYZ is defined, where the axes X and Z form a plane parallel to the mid-plane (main plane) of the optical component 10, and where the axis Y is oriented from the entry face to the exit face 12b. In the remainder of the description, the terms “front” and “rear” are understood to be relative to an orientation along the +Y direction.

The optical component 10 has two faces opposite one another, planar and parallel to the main plane, referred to as entry face 11a and exit face 12b. It is intended to receive the incident light rays through the entry face 11a (entry diopter) and transmit them through the exit face 12b (exit diopter). It is formed by two transparent layers 11, 12 (which may be plates, films, sheets, etc.) attached to each other. The main plane can be the plane located at equal distances between the entry faces 11a and exit faces 12b, or even the plane located at the rear face 11b of the first layer 11.

The first layer 11 includes the entry face 11a and an opposite rear face 11b. These faces are flat and parallel to each other. It is made of a material that is transparent to the light to be transmitted. It may be a plastics material, such as polymethyl methacrylate. As indicated previously, the entry face 11a forms the entry diopter of the optical component. The entry face 11a may be coated with a layer minimizing the reflection R1.

Micro-recesses 13 in the form of a truncated pyramid are formed in the layer 11 from the rear face 11b. They form non-through notches made in the layer 11, and have an inner surface oriented towards the rear face 11b and therefore towards the second layer 12. They are filled by the transparent glue, or by a filler material having the same refractive index as that of the layers 11, 12 and of the glue.

The micro-recesses 13 are identical or similar to those described in the document WO 2021/104739 A1 as well as in the document by Martinez et al. entitled Optimized Design and Manufacturing Process of Diffuse Micro Corner Cubes for Head Up Projection Display Applications, Proceedings Volume 12443, Advances in Display Technologies XIII; U.S. Pat. No. 1,244,301 (2023).

The micro-recesses 13 are retroreflective in that the reflected rays have a reflection direction parallel to the direction of incidence. They are therefore reflective, either by total internal reflection or by metallic type reflection. In the case of an internal total reflection, the optical index of the medium filling the micro-recess 13 (and possibly that of the layer 12) is higher than that of the layer 11. Moreover, in the case of a metal-type reflection, the inner face of each micro-recess is covered by a thin reflective layer (not shown), made for example of at least one metal material. This thin reflective layer is only present in the inner surface of the micro-recesses.

As illustrated in detail in FIG. 1B, each micro-recess 13 has a truncated pyramid shape (which is a particular trinhedral shape) with a quadrilateral base. The base of the truncated pyramid is a quadrilateral EFGH, and the top face of the truncated pyramid, i.e. the bottom of the micro-recess, is the quadrilateral ABCD. The base EFGH is coplanar with the rear face 11b of the layer 11. The bottom ABCD is parallel to the main plane of the optical component 10. The inner surface of the micro-recess 13 is thus formed on the one hand by the four lateral walls joining the base to the bottom, and on the other hand by the bottom ABCD.

The side walls are ABFE, ADHE, CDHG and BCGF. Here, the side walls ABFE and ADHE are substantially orthogonal to each other and to the bottom ABCD (and therefore to the main plane P). The point A is common to these side walls ABFE and ADHE and to the bottom ABCD. These three surfaces thus form a right-angled trihedron, also called a cube-corner, which is intended to retroreflect incident light rays. On the other hand, the side walls CDHG and BCGF are not intended to participate in retroreflection. They are inclined with respect to the bottom ABCD, and each forms an angle of more than 90° with respect to it.

Furthermore, the base EFGH and the bottom ABCD are preferably square, and the length of the side of the square base EFGH is preferably equal to twice the length of the side of the square bottom ABCD. This improves the retroreflection efficiency of the micro-recess. The dimension of the diagonals FH and EG is noted as “a”. In addition, the depth of the truncated pyramid, i.e. the distance AE, is noted as “h”.

The micro-recesses 13 are here arranged regularly in a plane XZ parallel to the main plane (mean plane) of the optical component 10, with a constant pitch p. However, they may be arranged irregularly, for example randomly or semi-randomly.

The micro-recesses 13 therefore form retroreflective portions, and are each surrounded by a transparent portion allowing the transmission of the incident light from the entry face 11a to the exit face 12b. Thus, the optical component 10 is partially retroreflective and partially transparent.

The second layer 12 includes a front face 12a, by which it is attached to the layer 11, and the opposite exit face 12b which forms the exit diopter. These faces 12a, 12b are planar and parallel to each other. It is made of a material that is transparent to the light to be transmitted. It may be a plastics material, such as polymethyl methacrylate. Preferably, the refractive indices of the two layers 11, 12 and of the transparent adhesive are substantially identical (however, they may be different, as indicated previously, when the reflection in the micro-recesses 13 is of the internal total reflection type). The layer 12 has a constant thickness D, formed by the distance between the rear face 11b and the exit face 12b along the axis Y.

Other configurations are possible. Thus, the second layer 12 can be formed of a material deposited on the rear face 11b of the layer 11, the material of which continuously fills the interior space of the micro-recesses, and which has the X it face 12b, planar and parallel to the entry face 11a.

In operation, the entry face 11a is illuminated by a light beam I₀ having a non-zero angle of incidence α₀. The ray of intensity I₀ is then refracted at the entry face 11a and forms the ray of intensity I₁. This is transmitted without refraction to the interface between the two layers 11, 12, and is then reflected by the exit face 12b to form the real intensity I₁ᵣ. This is then reflected back by the micro-recess 13 in the form of a truncated pyramid, and is then refracted at the exit face 12b to form the ray of intensity I₂. Moreover, the light not passing through the micro-recesses but passing through the transparent portions is then transmitted by the optical component without being retroreflected.

The useful transmission rate of the incident ray I0 to obtain the deviated transmitted ray I₂ is noted Tu. It is said to be useful insofar as the radius I₂ is that which participates in forming an image in a plane-symmetrical manner with respect to the object to be imaged. We have: Tu=(1−R1)×Tcc×R2×γ×Rcc×(1−R2), where R1 is the reflection rate on the entry face 11a; Tcc is the transmission rate between the micro-recesses at the interface between the two layers (this is the spatial coverage rate of the micro-recesses); R2 is the reflection rate at the exit face 12b; γ is a rate of illumination of a micro-recess by a light beam I 1r (which depends on the values of Tcc and the thickness D; this is the overlap between the complementary pattern of the micro-recess 13 generated by reflection on the exit face 12b and the pattern of the micro-recess 13); and Rcc is the retroreflection rate of the micro-recesses.

By way of example, for the following values R1=1%; Tcc=50%; R2=50%; γ=100% and Rcc=100%, a useful transmission rate of 12.4% is obtained, which is comparable to the efficiencies of the floating-image formation systems of the Pepper Ghost type that use semi-reflective blades.

It should be noted that the optical component 10 is configured, in terms of thickness D of the layer 12 and dimensions and orientation of the micro-recesses 13, according to the angle and the plane of incidence to benefit from the ‘trinhedron’ effect. On the one hand, the micro-recesses 13 are oriented so that the diagonal AG is contained in the incidence plane of the incident rays I₁ᵣ. On the other hand, as indicated by the documents Martinez et al 2023 and WO2021/104739A1, the relationship that connects the diagonal a and the depth h of the truncated-pyramid micro-recess with the angle of incidence α₁ of the light rays I₁ᵣ is:

$$a = 2 h \times tan [ {sin}^{- 1} ( \frac{1}{n} sin {α}_{1} ) ]$$

where n is the refractive index of the optical component.

FIG. 2 schematically illustrates micro-recesses 13 of the optical component 10 of FIG. 1A, with the aim of highlighting the formation of the cast shadow. The micro-recesses 13 are shown here for simplicity in the form of a cubic notch, but the problem is the same with truncated pyramids.

It appears from the sizing of the micro-recesses 13 that, for an angle of incidence of 45° and an optical index of 1.5, a micro-recess of 60 μm deep has a diagonal of approximately 64 μm. Also, insofar as, on the one hand, the micro-recesses are oriented towards the exit face 12b and no longer, as in the prior art, towards the entry face 11a, and on the other hand the depth and the diagonal have values of the same order, the drop-shadow effect of the truncated pyramid is present and not negligible. The cast shadow is here represented by the dashed area formed by the continuous-line ray I₁ which is flush with the right trihedron.

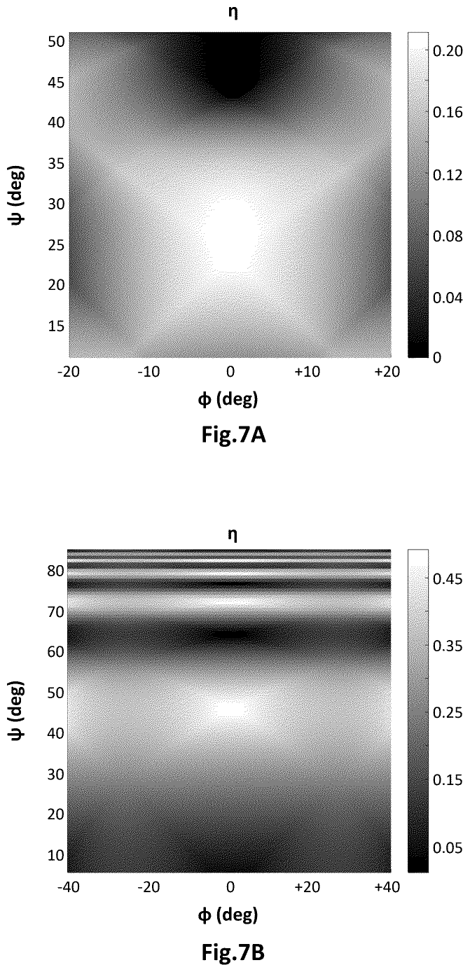

If a retroreflective efficiency of the rays I₁ (and therefore I₁ᵣ) defined by the equation: η=Tcc×γ is denoted η, simulations carried out by the inventor show that the theoretical value of 50% (i.e. with the values Tcc=50% and γ=100% indicated previously) decreases to an effective value close to approximately 25% due to the cast shadow (cf. in particular FIG. 7A described later). The useful transmission rate Tu then changes from about 12% to about 6%.

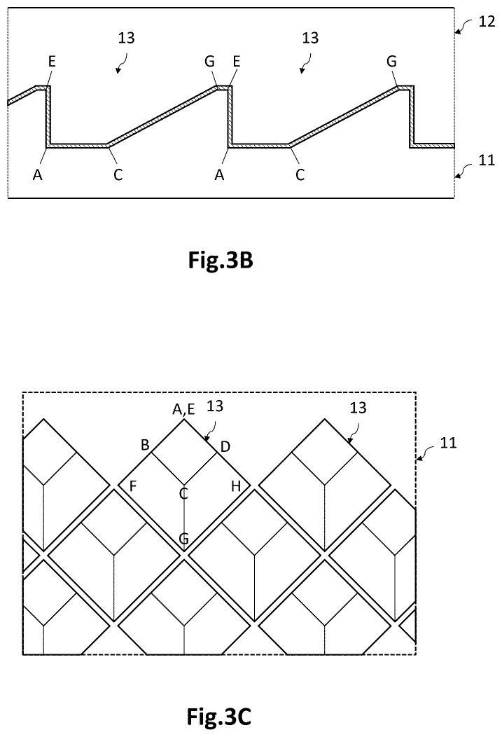

FIGS. 3A to 3C illustrate an optical component 10 according to an embodiment which has an improved retroreflection efficiency η of the rays I₁, and therefore an improved useful transmission rate Tu. FIG. 3A is a schematic and partial cross-sectional view of the optical component 10. FIG. 3B illustrates in more detail adjacent micro-recesses 13 of FIG. 3A, and FIG. 3C is a plan view of the micro-recesses 13 of FIG. 3A.

According to the invention, the optical component 10 is similar to that of FIG. 1A but is essentially distinguished from it in that the truncated-pyramid micro-recesses 13 are arranged so as to form several distinct retroreflective strips parallel to each other, which are separated two by two by a transparent longitudinal region that does not contain micro-recesses. Moreover, in the same retroreflective strip, the micro-recesses are up against each other (juxtaposed) so as to avoid transmission of the light from the entry face, and are oriented along a transverse axis of the retroreflective strip.

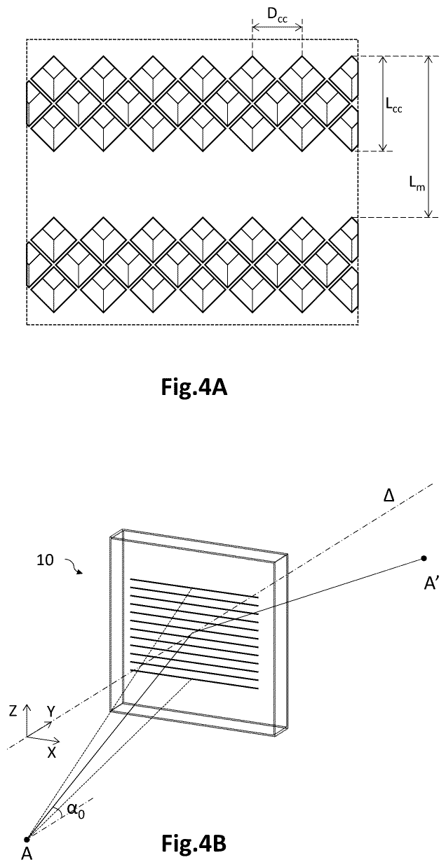

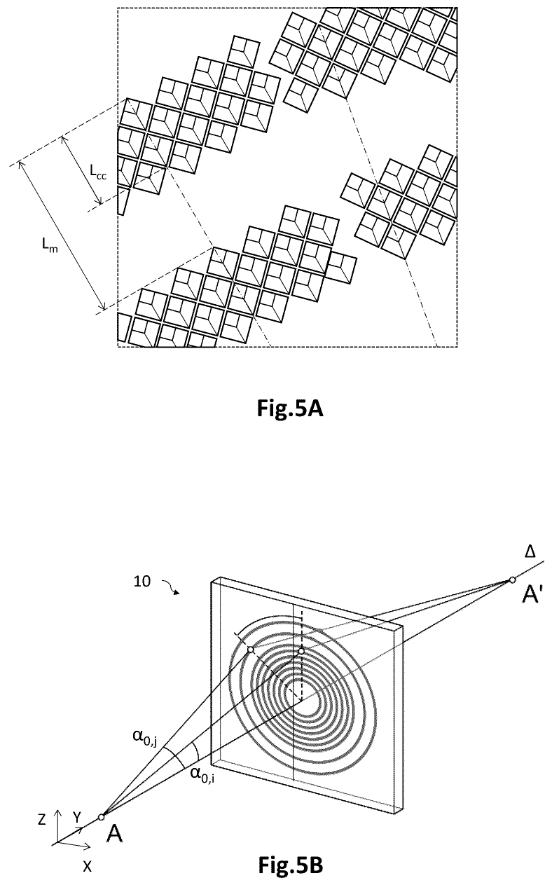

The retroreflective strips are formed from a regular arrangement of micro-recesses 13 at the pitch Dcc along the longitudinal axis, and have a width Lcc. The width Lcc is greater than the value an of the diagonal AG of the micro-recesses. The strips are separate and parallel to each other. They are arranged transversely with a pitch Lm, which can be constant or not. Two strips are separated by a transparent longitudinal region that does not contain micro-recesses. This transparent longitudinal region thus has a width Lm-Lcc. The dimensions Lcc and Lm are illustrated in FIG. 4A. Moreover, the strips are parallel to each other: they can be straight as in FIG. 4A or concentric as in FIG. 5A. Finally, one and the same strip can extend longitudinally in a continuous or discontinuous manner (by section, as in FIG. 5A)

Preferably, the transverse spacing pitch Lm of the retroreflective strips is substantially equal to 2 times Lcc: Lm=2×Lcc. However, the Lcc/Lm ratio may be between 30% and 70%, and preferably between about 40% and 60%. Preferably, it is substantially equal to 50%. Furthermore, the width Lcc is a multiple of the value a of the diagonal AG: Lcc=N×a, where N>2. The higher the N value, the more limited the drop-shadow effect is. However, the N value cannot be too high at the risk of the user seeing the retro-reflective strips. For example, if a visual acuity of 0.5 arcmin and a distance between the optical component and the user of 0.5 m to 1 m are considered, a width Lcc of the strips of the order of about 70 to 140 μm is obtained. With a dimension a of micro-recesses equal to approximately 35 μm, the value N is then between 2 and 4. A dimension a at least equal to 10 μm can be envisaged, which would allow having a number N in the order of about 7 to 14. Also, preferably, the number N is between 2 and 15.

The micro-recesses 13 are oriented substantially along the transverse axis of the retroreflective strips, this transverse axis being preferably included in the incidence plane of the incident beam I₀. In other words, preferably, the diagonal AG of each micro-recess (diagonal formed by the common point A of the retroreflective trinhedron and the opposite point G) is oriented substantially orthogonally to the longitudinal axis. Thus, the micro-recesses are oriented substantially along the plane of incidence of the light beam I₀ which illuminates the optical component.

The micro-recesses 13 preferably have a square base: the diagonals AG and FH here have the same value a. This makes it possible to improve the retroreflection efficiency, and also makes it possible to obtain a regular, high-density tiling that minimizes the intermediate surface between two neighboring micro-recesses.

The micro-recesses 13 are contiguous, i.e. up against each other. The intermediate surface between two neighboring micro-recesses is negligible or sufficiently small to limit or completely avoid the transmission of the rays I₁ in the retroreflective strips. Preferably, the transverse distance of this intermediate surface, defined as being the distance between an edge of the base EFGH with that of a neighboring micro-recess, is less than one fifth, or even one tenth, of the depth h of the micro-recesses. It can also be zero (the edge of a micro-recess touches that of the neighboring micro-recess).

Preferably, the reflective layer extends continuously in the surface of the same retroreflective strip, and therefore on the inner surface of the micro-recesses 13, but also on the intermediate surface (when present) of the face 11b located between the edges of the bases EFGH of the neighboring micro-recesses 13.

Moreover, to promote the coverage of the micro-recesses 13 by the light beam I₁ then reflected by the output diopter to form the beam I₁ᵣ, the distance Lm and the thickness D are adjusted according to the angle of incidence α₁ of the rays I₁ by the following equation:

$$D = \frac{Lm}{4 \times tan {α}_{1}} mod \frac{Lm}{2 \times tan {α}_{1}}$$

where “mod” is the modulo operator.

FIG. 4A illustrates an example of strip arrangement of the micro-recesses 13, here in straight strips. FIG. 4B illustrates an example of optical component 10 where the retroreflective strips are straight. In this example, the object to be imaged is offset with respect to the optical axis Δ of the optical component.

As shown in FIG. 4A, the retroreflective strips here extend longitudinally substantially straight. The micro-recesses 13 have a square base; the diagonals EG and FH have the value a. Here, the distance Dcc is substantially equal to the distance a, and the width Lcc is here substantially equal to 2 times the distance a. Moreover, the transverse arrangement pitch of the retroreflective strips Lm is equal to 2 times the width Lcc. Other arrangements of the micro-recesses are possible, where they are all oriented in the same way and have the same dimensions.

As shown in FIG. 4B, an optical component 10 which has such an arrangement of the micro-reflective strips can be used as an imaging optical system having a plane-symmetrical transmission. Thus, it forms the image point A′ from the light rays coming from the object point A. Unlike conventional lenses, the optical component 10 deflects and converges the rays in a plane-symmetrical manner with respect to the main plane (mean plane) of the optical component. Thus, for a point A contained in the plane YZ and distant from the optical axis by a given value, the image point A′ is also contained in the same plane YZ and is distant by the same value and along the same direction with respect to the optical axis as the point A. The point A′ therefore has planar symmetry with the point A.

It should be noted that the light beam I₀ has an angle of incidence between do-da and α₀+δα, so that the upper strips receive the rays with an angle of incidence α₀+δα, the middle strips receive the rays with an angle α₀, and the lower strips with an angle α₀−δα. The micro-recesses of all strips can be sized according to the same mean angle of incidence α₀, or the strips can be sized according to the local angle of incidence (thus, for example, the upper strips according to α₀+δα, the middle strips according to α₀, and the lower strips according to α₀−δα). Preferably, the micro-recesses of one and the same strip have the same transverse orientation (i.e. in the plane parallel to the plane of incidence YZ passing through A). Preferably, the micro-recesses have the same orientation from one retroreflective strip to another.

FIG. 5A illustrates another example of strip arrangement of the micro-recesses 13, here in concentric circles. FIG. 5B illustrates an example of an optical component where the retroreflective strips have such an arrangement. In this example, the object to be imaged is on the optical axis Δ of the optical component 10.

As shown in FIG. 5A, the retroreflective strips extend substantially circularly and concentrically, being centered on the optical axis Δ. Each strip therefore forms a ring in the main plane of the optical component. Here, the orientation of the micro-recesses is uniform per strip section. Thus, each strip is formed of several longitudinal sections which extend in a straight line and where the micro-recesses of the same section have the same orientation. The orientation of the micro-recesses 13 therefore depends on the corresponding mean plane of incidence. Thus, one and the same strip is formed of M separate sections inclined with respect to a vertical axis parallel to the Z axis and passing through the central axis by an angle βᵢ, with i ranging from 1 to M. FIG. 5A illustrates a section inclined by the angle βᵢ as well as the adjacent section inclined by the angle βᵢ₊₁. The value M is large enough to limit the spacing between two neighboring sections of the same retro-reflective strip on the one hand, and so that the strips remain substantially circular.

As in the example of FIG. 4B, the optical component 10 can be used as a plane-symmetric imaging optic. This is because the image A′ of the point A is located on the optical axis at the same distance from the optical component as the point A, regardless of the position of the latter. The optical component is therefore plane-symmetrical, unlike a conventional lens.

Each retroreflective strip is formed by straight sections approximating a circle. The circles thus approximated are substantially concentric and centered on the optical axis Δ. In other words, each circle is approximated by a polygon, preferably regular, and each section is centered on one side of this polygon.

As shown in FIG. 5A, the rings formed by two adjacent retroreflective strips are separated by a transparent longitudinal portion not comprising micro-recesses. This transparent longitudinal portion extends into the spacings between adjacent sections of the retroreflective strips with a larger diameter. Thus, the spacing between two adjacent sections of the same retroreflective strip is not part of the strip itself.

Preferably, as is the case here, the spacing between two adjacent sections of the same retroreflective strip is such that it is not possible to insert therein a micro-recess that would be up against a micro-recess of either of the adjacent sections. The larger M, the smaller the distance between adjacent links.

In FIG. 5A, the transverse axis of a retroreflective strip is shown in dashed-and-dotted lines at the level of two adjacent portions of the strip. Preferably, the plane in which the retroreflective strips extend is divided into angular sectors such that, within one and the same angular sector, the sections belonging to the various strips are parallel to each other. In other words, in one and the same angular sector, the transverse axis of one retroreflective strip is parallel to the transverse axes of the other retroreflective strips. At each section of a retroreflective strip, its transverse axis preferably passes substantially through the center of all the circles approximated by the retroreflective strips.

Since the rays emitted from point A have different angles of incidence, ranging from 0° to α_{0,max}, the micro-recesses 13 are preferably sized according to the corresponding angle of incidence. Thus, by way of example, for a depth h of 60 μm and an optical index n of 1.5 of the transparent material, the micro-recesses 13 of the strip located near the optical axis may have a dimension a of about 15 μm (for an angle of incidence of about) 10°, while those of the strip furthest from the optical axis may have a dimension a of about 100 μm (for an angle of incidence of about 60°).

For this purpose, note do the angle of incidence of the rays I₀ which scans the values ranging from 0° to α_{0,max}. Note i the rank of the concentric strips, with i=1 for the strip closest to the optical axis Δ and i=P for the strip furthest away. Each strip can then be located between the angles of incidence α_{0,i} and α_{0,i+1}. The dimension a of the diagonals of the micro-recesses of the strip of rank i can then satisfy the equation:

$${a}_{i} = 2 h \times tan [ {sin}^{- 1} ( \frac{1}{n} sin \overline{{α}_{1. i}} ) ]$$

with: α̅_̅{̅1̅.̅i̅}̅=(α_{1,i+1}+α_{1.i})/2.

Furthermore, the thickness D of the layer 12 may be chosen substantially equal to N times h:D=N×h. Remember that N is the number of micro-recesses 13 across the width of the strip considered, and that h is the depth of the micro-recesses 13. Furthermore, between the angles α_{1,i} and α_{1,i+1}, several concentric strips may be present. The number Nbᵢ of the strips present in the angular increment α_{1,i+1}−α_{1,i} can be calculated by the equation:

$${Nb}_{i} = Z \times \frac{tan {α}_{0 , i + 1} - tan {α}_{0 , i}}{4 \times tan \overline{{α}_{1. i}}}$$

where Z is the distance between the object to be imaged and the optical component along the optical axis. For example, for a depth h of 45 μm and a number N of 4, a distance Z of 10 cm, and an angular increment of 2°, and finally for a minimum value of the dimension a of 5 μm, it is observed that the value a increases linearly from 5 μm to 60 μm while α₀ changes from 5° to 60°, and that the number Nb decreases from 44 strips for α₀=5° (hence 44 strips of micro-recesses of 5 μm) to 9 strips around 40° where the micro-recesses have a dimension a of approximately 40 μm.

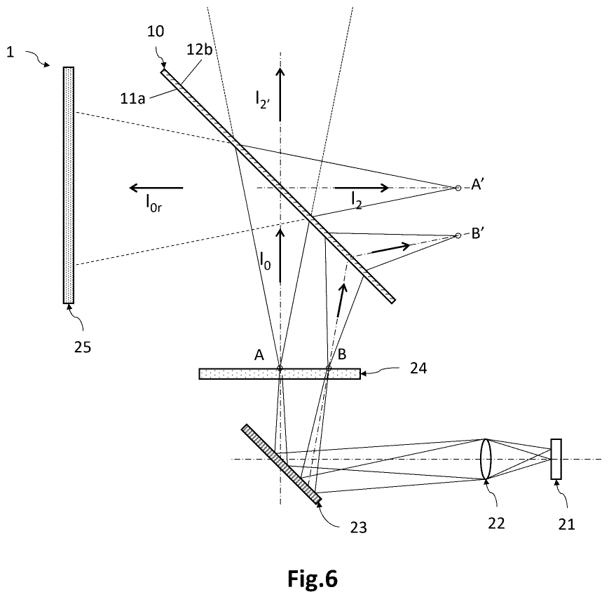

FIG. 6 illustrates a floating imaging system 1 which includes an image-forming component and an optical component 10 according to an embodiment.

The image-forming component here includes a projector 21, 22 of an image to be displayed, a reflection mirror 23, and a transparent and diffusing structure 24. It is associated with the optical component 10, and here, an absorbent structure 25. The projector includes an image source 21 (screen displaying the image) associated with a projection optic 22. Alternatively, the image-forming component may be a screen (less energy-efficient (Lambertian emission, high diffusion) but also less bulky (the diffuser is integrated therein)).

The image displayed by the source 21 is thus projected onto a transparent and diffusing structure 24 by the projection optic 22 and the reflection mirror 23. The image diffused by the diffusing structure 24 includes in particular points A and B. The light beams from the diffused image are noted I₀, with reference to FIG. 3A.

The rays I₀ of the image diffused by the diffusing structure 24 are incident on the entry face 11a of the optical component 10. Some of these rays, noted lor, are reflected by this entry face 11a, then are absorbed by the absorbent structure 25.

Others, noted I_{2′}, are refracted and transmitted through the transparent longitudinal regions of the optical component 10. They emerge from the optical component through the exit face 12b with the same angle of incidence as the rays I₀.

On the other hand, some I₂ of the rays I₀ are reflected by the exit face 12b towards the micro-recesses, then are retroreflected by the retroreflective strips with micro-recesses, and finally refracted out of the optical component 10 through the exit face 12b. They then converge to form the image points A′ and B′, which are placed in planar symmetry with respect to the main plane of the optical component 10.

Thus, the optical component 10 separates the lower image-generation space from the image to be viewed and the upper image-viewing space. This floating imaging system 1 makes it possible to limit the phantom replication effect that is present in the case where the floating imaging system would comprise a semi-reflective blade instead of our optical component as well as a retroreflective surface with cube corners instead of our absorber. Such a system is described in particular in the article by Yoshimizu & Iwase entitled Radially arranged dihedral corner reflector array for wide viewing angle of floating image without virtual image, Opt. Express 27 (2), 918-927 (2019). Furthermore, the viewed image is less fuzzy than in this example of the prior art since it is located closer to the floating imaging system than in the examples of the prior art.

FIGS. 7A and 7B illustrate examples of angular change in the backscattering efficiency η of the rays I₁ and therefore also of the rays I₁ᵣ. The value of the efficiency η relates to an optical component 10 of a floating imaging system similar to that of FIG. 6, in the case where the user would have the eyes located in the eye box of the system. The viewing angle φ is the one that scans the horizontal plane XY and the viewing angle φ is the one that scans the vertical plane YZ. These angular changes are obtained by digital simulation using the Matlab® software, taking into account the cast shadow effects by a set of geometric relationships.

FIG. 7A corresponds to the case where the optical component is similar to that of FIG. 1A, i.e. where the micro-recesses are not arranged in separate retroreflective strips and are not up against each other. It appears that the efficiency n has a maximum value in the order, here, of approximately 20%, consistent with the maximum theoretical value of 25% indicated previously. This degradation of efficiency η is due, as shown above, to a cast shadow effect.

FIG. 7B corresponds to the case where the optical component is similar to that of FIG. 3A, i.e. where the micro-recesses are arranged in separate retroreflective strips while being attached to each other therein. It appears that the efficiency η has a maximum value of around 45% here. As we have shown earlier, this arrangement makes it possible to limit the cast shadow effect, which allows the efficiency η to approach the maximum theoretical value of 50%. This noticeable improvement in efficiency η results in fact in an improvement in the useful transmission rate Tu, which improves the performance of the optical component and therefore of the floating imaging system.

Furthermore, it should be noted that the efficiency η is better when the step Dcc is as small as possible, i.e. when it corresponds to that of FIG. 4A where Dcc is equal to the value a of the diagonal FH. In fact it has a high value for a wide angular range of 15° of the horizontal angle ¢.

Particular embodiments have just been described. Different alternatives and modifications will become apparent to the person skilled in the art.

1. An optical component, extending in a main plane, and having an entry face and an exit face opposite, planar and parallel to the main plane, comprising:
a first transparent layer, having the entry face, and a second face opposite, planar and parallel to the main plane, and comprising retroreflective micro-recesses, in the form of a truncated pyramid, extending from the second face;
a second transparent layer, having the exit face, and extending on and in contact with the second face of the first layer and the micro-recesses;
wherein:
the micro-recesses are arranged as separate retroreflective strips parallel to one another, such that the retroreflective strips are separated two by two by a transparent longitudinal portion not comprising micro-recesses,
and such that the micro-recesses of one and the same retroreflective strip are up against each other and oriented along a transverse axis of the retroreflective strip.

2. The optical component according to claim 1, wherein the micro-recesses of one and the same strip all have the same dimensions.

3. The optical component according to claim 1, wherein the micro-recesses each have a square top face of the truncated pyramid and a square base, parallel to the top face and coplanar with the second face of the first layer.

4. The optical component according to claim 3, wherein the micro-recesses each have a trihedron formed by the top face and two lateral faces orthogonal to each other and to the top face.

5. The optical component according to claim 4, wherein the micro-recesses each have a first diagonal connecting a common point, shared by the top face and two lateral faces of the trihedron, to the opposite point of the base, wherein this diagonal is substantially oriented along the transverse axis of the retroreflective strip.

6. The optical component according to claim 5, wherein, in one and the same retroreflective strip, the micro-recesses are arranged periodically according to a pitch substantially equal to the dimension of a diagonal from the orthogonal base to the first diagonal.

7. The optical component according to claim 1, wherein a reflective layer covers the inner surface of the micro-recesses as well as an intermediate surface of the second face of the first layer disposed between two neighboring micro-recesses.

8. The optical component according to claim 1, wherein the retroreflective strips are straight or concentric.

9. The Optical component according to claim 1, wherein each retroreflective strip comprises, along its transverse axis, between 2 and 15 micro-recesses.

10. The optical component according to claim 1, the entry face of which is configured to be illuminated by a light beam with a non-zero mean angle of incidence α₀, which is refracted to form in a light beam having a non-zero angle α₁ with respect to an axis orthogonal to the main plane; wherein the retroreflective strips are arranged next to each other at a pitch Lm and wherein the second layer has a thickness D; such that the values D and Lm are selected to satisfy the equation:
$$D = \frac{Lm}{4 \times tan {α}_{1}} mod \frac{Lm}{2 \times tan {α}_{1}} .$$

11. The optical component according to claim 1, wherein two neighboring micro-recesses of one and the same retroreflective strip are spaced apart from each other by a distance at most equal to a fifth of their depth

12. The optical component according to claim 1, wherein two neighboring micro-recesses of one and the same retroreflective strip are spaced apart from each other by a distance at most equal to a tenth of their depth.

13. A floating imaging system, comprising:
an image-forming component, configured to provide an image;
the optical component according to claim 1, wherein its entry face is oriented towards the image-forming component and disposed inclined to an optical axis of the latter.

14. The floating imaging system according to claim 13, comprising an absorbent structure disposed opposite the entry face of the optical component so as to receive the light beams coming from the image-forming component and reflected by the entry face.

15. The floating imaging system according to claim 13, wherein the image-forming component comprises: a projector of an image, comprising an image source and an optical system; and a transparent diffuser, disposed in the image plane of the optical system, configured to transmit and backscatter the image received from the projector.
